(19) United States
(12) Patent Application Publication
(10) Pub. No.: US 2026/0223068 A1
(43) Pub. Date: Jul. 30, 2026

(54) PAGING SCHEME IN MULTI-CELL CAMPING

(71) Applicant: Nokia Technologies Oy, Espoo (FI)

(72) Inventors: Halit Murat GÜRSU, Munchen (DE); Philippe GODIN, Versailles (FR); Ugur Baran ELMALI, Munich (DE); Ömer BULAKCI, Munich (DE); Muhammad NASEER-UL-ISLAM, Munich (DE); Ahmad AWADA, Munich (DE); György Tamás WOLFNER, Budapest (HU)

(21) Appl. No.: 19/142,139

(22) PCT Filed: Dec. 4, 2023
(86) PCT No.: PCT/EP2023/084076

§ 371 Date: Jun. 20, 2025

(30) Foreign Application Priority Data
Dec. 21, 2022 (GB) 2219340.3

(51) Int. Cl. H04W 68/02; H04W 76/15

(52) U.S. Cl. CPC H04W 68/02; H04W 76/15

(57) ABSTRACT

Embodiments of the present disclosure relate to paging scheme in multi-cell camping. A terminal device receives, from a network device, a multi-cell camping configuration indicative of a plurality of paging configurations for the terminal device to monitor paging occasions from a set of cells. A cell among the set of cells supports at least one of a set of allowed slices of the terminal device. The terminal device camps on at least one cell among the set of cells based on the multi-cell camping configuration. The terminal device receives a paging message associated with an allowed slice among the set of allowed slices from one of the at least one cell based on the multi-cell camping configuration. The cell of the at least one cell supports the allowed slice. In this way, an enhanced paging scheme without homogenous slice support requirements in RA or even in TA may be provided.

### FIELD

Example embodiments of the present disclosure generally relate to the field of telecommunication, and in particular, to terminal devices, network devices, core network devices, methods, apparatuses and a computer readable storage medium for performing paging in multi-cell camping.

### BACKGROUND

Network slicing is a key 5G feature to support different services using the same underlying mobile network infrastructure. Network slices can differ either in their service requirements like Ultra-Reliable Low Latency Communication (URLLC), vehicle-to-anything (V2X) and enhanced Mobile Broadband (eMBB) or the tenant that provides those services.

Registration area (RA) is a list consisting of tracking areas (TAs), which is configured to a user equipment (UE) by the network. RA has been used to track UE for paging purposes and has the role to maintain allowed slices of the UE. According to current specifications, it has been agreed to have homogenous slice support within a TA, as well as homogenous support of the allowed slices within the RA of the UE. However, recently, the RA is expected to comprise multiple TAs that are not supporting all allowed slices of the UE. Thus, enhancements on paging procedures are still needed in such scenarios.

### SUMMARY

In general, example embodiments of the present disclosure provide a solution for paging in multi-cell camping.

In a first aspect, there is provided a terminal device for a radio access network. The terminal device comprises at least one processor and at least one memory storing instructions. The instructions, when executed by the at least one processor, cause the terminal device at least to: receive, from a network device for the radio access network, a multi-cell camping configuration indicative of a plurality of paging configurations for the terminal device to monitor paging occasions from a set of cells, a cell among the set of cells supporting at least one of a set of allowed slices of the terminal device; camp on, based on the multi-cell camping configuration, at least one cell among the set of cells; and receive, based on the multi-cell camping configuration, a paging message associated with an allowed slice among the set of allowed slices from one of the at least one cell, the one of the at least one cell supporting the allowed slice.

In a second aspect, there is provided a network device for a radio access network. The network device comprises at least one processor; and at least one memory storing instructions. The instructions, when executed by the at least one processor, cause the network device at least to: transmit, to a terminal device for the radio access network, a multi-cell camping configuration indicative of a plurality of paging configurations for the terminal device to monitor paging occasions from a set of cells, a cell among the set of cells supporting at least one of a set of allowed slices of the terminal device; and transmit, to a core network device, the multi-cell camping configuration.

In a third aspect, there is provided a network device for a radio access network. The network device comprises at least one processor; and at least one memory storing instructions. The instructions, when executed by the at least one processor, cause the network device at least to: receive, from a core network device, a multi-cell camping configuration indicative of a plurality of paging configurations for a terminal device to monitor paging occasions from a set of cells, a cell among the set of cells supporting at least one of a set of allowed slices of the terminal device; and based on receiving, from the core network device, a first paging message for the terminal device, transmit a second paging message to the terminal device from a cell supporting an allowed slice among the set of allowed slices based on the multi-cell camping configuration, the second paging message being associated with the allowed slice.

In a fourth aspect, there is provided a core network device. The core network device comprises at least one processor; and at least one memory storing instructions. The instructions, when executed by the at least one processor, cause the core network device at least to: receive, from a first network device for a radio access network, a multi-cell camping configuration indicative of a plurality of paging configurations for a terminal device to monitor paging occasions from a set of cells, a cell among the set of cells supporting at least one of a set of allowed slices of the terminal device; and transmit, to a second network device for the radio access network, the multi-cell camping configuration and a paging message for the terminal device, the paging message being associated with an allowed slice among the set of allowed slices.

In a fifth aspect, there is provided a method. The method comprises: receiving, at a terminal device for a radio access network and from a network device for the radio access network, a multi-cell camping configuration indicative of a plurality of paging configurations for the terminal device to monitor paging occasions from a set of cells, a cell among the set of cells supporting at least one of a set of allowed slices of the terminal device; camping on, based on the multi-cell camping configuration, at least one cell among the set of cells; and receiving, based on the multi-cell camping configuration, a paging message associated with an allowed slice among the set of allowed slices from one of the at least one cell, the one of the at least one cell supporting the allowed slice.

In a sixth aspect, there is provided a method. The method comprises: transmitting, at a network device for a radio access network and to a terminal device for the radio access network, a multi-cell camping configuration indicative of a plurality of paging configurations for the terminal device to monitor paging occasions from a set of cells, a cell among the set of cells supporting at least one of a set of allowed slices of the terminal device; and transmitting, to a core network device, the multi-cell camping configuration.

In a seventh aspect, there is provided a method. The method comprises: receiving, at a network device for a radio access network and from a core network device, a multi-cell camping configuration indicative of a plurality of paging configurations for a terminal device to monitor paging occasions from a set of cells, a cell among the set of cells supporting at least one of a set of allowed slices of the terminal device; and based on receiving, from the core network device, a first paging message for the terminal device, transmitting a second paging message to the terminal device from a cell supporting an allowed slice among the set of allowed slices based on the multi-cell camping configuration, the second paging message being associated with the allowed slice.

In an eighth aspect, there is provided a method. The method comprises: receiving, at a core network device and from a first network device for a radio access network, a multi-cell camping configuration indicative of a plurality of paging configurations for a terminal device to monitor paging occasions from a set of cells, a cell among the set of cells supporting at least one of a set of allowed slices of the terminal device; and transmitting, to a second network device for the radio access network, the multi-cell camping configuration and a paging message for the terminal device, the paging message being associated with an allowed slice among the set of allowed slices.

In a ninth aspect, there is provided an apparatus. The apparatus comprises means for receiving, at a terminal device for a radio access network and from a network device for the radio access network, a multi-cell camping configuration indicative of a plurality of paging configurations for the terminal device to monitor paging occasions from a set of cells, a cell among the set of cells supporting at least one of a set of allowed slices of the terminal device; means for camping on, based on the multi-cell camping configuration, at least one cell among the set of cells; and means for receiving, based on the multi-cell camping configuration, a paging message associated with an allowed slice among the set of allowed slices from one of the at least one cell, the one of the at least one cell supporting the allowed slice.

In a tenth aspect, there is provided an apparatus. The apparatus comprises means for transmitting, at a network device for a radio access network and to a terminal device for the radio access network, a multi-cell camping configuration indicative of a plurality of paging configurations for the terminal device to monitor paging occasions from a set of cells, a cell among the set of cells supporting at least one of a set of allowed slices of the terminal device; and means for transmitting, to a core network device, the multi-cell camping configuration.

In an eleventh aspect, there is provided an apparatus. The apparatus comprises means for receiving, at a network device for a radio access network and from a core network device, a multi-cell camping configuration indicative of a plurality of paging configurations for a terminal device to monitor paging occasions from a set of cells, a cell among the set of cells supporting at least one of a set of allowed slices of the terminal device; and means for based on receiving, from the core network device, a first paging message for the terminal device, transmitting a second paging message to the terminal device from a cell supporting an allowed slice among the set of allowed slices based on the multi-cell camping configuration, the second paging message being associated with the allowed slice.

In a twelfth aspect, there is provided an apparatus. The apparatus comprises means for receiving, at a core network device and from a first network device for a radio access network, a multi-cell camping configuration indicative of a plurality of paging configurations for a terminal device to monitor paging occasions from a set of cells, a cell among the set of cells supporting at least one of a set of allowed slices of the terminal device; and means for transmitting, to a second network device for the radio access network, the multi-cell camping configuration and a paging message for the terminal device, the paging message being associated with an allowed slice among the set of allowed slices.

In a thirteenth aspect, there is provided an apparatus. The apparatus comprises receiving circuitry configured to receive, from a network device for a radio access network, a multi-cell camping configuration indicative of a plurality of paging configurations for the apparatus to monitor paging occasions from a set of cells, a cell among the set of cells supporting at least one of a set of allowed slices of the apparatus; camping circuitry configured to camp on, based on the multi-cell camping configuration, at least one cell among the set of cells; and receiving circuitry configured to receive, based on the multi-cell camping configuration, a paging message associated with an allowed slice among the set of allowed slices from one of the at least one cell, the one of the at least one cell supporting the allowed slice.

In a fourteenth aspect, there is provided an apparatus. The apparatus comprises transmitting circuitry configured to transmit, to a terminal device for a radio access network, a multi-cell camping configuration indicative of a plurality of paging configurations for the terminal device to monitor paging occasions from a set of cells, a cell among the set of cells supporting at least one of a set of allowed slices of the terminal device; and transmitting circuitry configured to transmit the multi-cell camping configuration to a core network device.

In a fifteenth aspect, there is provided an apparatus. The apparatus comprises receiving circuitry configured to receive, from a core network device, a multi-cell camping configuration indicative of a plurality of paging configurations for a terminal device for a radio access network to monitor paging occasions from a set of cells, a cell among the set of cells supporting at least one of a set of allowed slices of the terminal device; and transmitting circuitry configured to transmit a second paging message to the terminal device from a cell supporting an allowed slice among the set of allowed slices based on the multi-cell camping configuration based on receiving, from the core network device, a first paging message for the terminal device, the second paging message being associated with the allowed slice.

In a sixteenth aspect, there is provided an apparatus. The apparatus comprises receiving circuitry configured to receive from a first network device for a radio access network, a multi-cell camping configuration indicative of a plurality of paging configurations for a terminal device for the radio access network to monitor paging occasions from a set of cells, a cell among the set of cells supporting at least one of a set of allowed slices of the terminal device; and transmitting circuitry configured to transmit, to a second network device for the radio access network, the multi-cell camping configuration and a paging message for the terminal device, the paging message being associated with an allowed slice among the set of allowed slices.

In a seventeenth aspect, there is provided a non-transitory computer readable medium comprising program instructions for causing an apparatus to perform at least the method according to any one of the above fifth to eighth aspect.

In an eighteenth aspect, there is provided a computer program comprising instructions, which, when executed by an apparatus, cause the apparatus at least to perform at least the method according to any one of the above fifth to eighth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example communication network in which embodiments of the present disclosure may be implemented;

FIG. 1B illustrates a schematic diagram of an example scenario of a non-homogenous network slice support in a registration area;

FIG. 1C illustrates a schematic diagram of a paging procedure in the scenario of FIG. 1B in a related solution;

FIG. 1D illustrates a schematic diagram of a paging procedure in the scenario of FIG. 1B in another related solution;

FIG. 2 illustrates a flowchart illustrating a process for paging in multi-cell camping according to some embodiments of the present disclosure;

FIG. 3 illustrates a schematic diagram of a format of network slice identification;

FIGS. 4A and 4B illustrate an example of a process for paging in multi-cell camping in accordance with some example embodiments of the present disclosure;

FIG. 5 illustrates an exemplary UERadioPagingInformation message in accordance with some example embodiments of the present disclosure;

FIG. 6 illustrates a flowchart of a method implemented at a terminal device according to some embodiments of the present disclosure;

FIG. 7 illustrates a flowchart of a method implemented at a network device according to some embodiments of the present disclosure;

FIG. 8 illustrates a flowchart of another method implemented at a network device according to some embodiments of the present disclosure;

FIG. 9 illustrates a flowchart of a method implemented at a core network device according to some other embodiments of the present disclosure;

FIG. 10 illustrates a simplified block diagram of an apparatus that is suitable for implementing embodiments of the present disclosure; and

FIG. 11 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In cellular radio access technologies (RATs), paging is a procedure used by the network (NW) to inform the UE of an incoming call or data targeted for the UE. A paging message requests the UE to attach to the network and establish a non-access stratum (NAS) signaling connection with the network. The network uses the paging procedure mainly because the network does not know the location of the UE, e.g., when the UE is in idle mode. Thus, paging may be the first procedure performed by the network to establish a connection with the UE. The use of paging to initiate a connection from the network to the UE is similar to the random access procedure (RACH) used by the UE to initiate a connection with the network. Thus, the detection of a paging message by the UE is extremely important, as the failure of a UE to detect a paging message can lead to missed calls or lost data.

As discussed above, network slicing is a key 5G feature to support different services using the same underlying mobile network infrastructure. Network slices can differ either in their service requirements like URLLC, V2X and eMBB or the tenant that provides those services. A network slice is uniquely identified via the Single-Network Slice Selection Assistance Information (S-NSSAI). Current 3GPP specifications allow a UE to be simultaneously connected and served by at most eight slices corresponding to eight network slices meaning eight S-NSSAIs. On other hand, each cell may support tens or even hundreds of slices. For example, in current specifications, a Tracking Area (TA) can support up to 1024 network slices.

Registration area (RA) is a list consisting of TAs, which is configured to the UE by the network. RA has been used to track UE for paging purposes. If UE leaves the RA, UE will let the network know through non-access stratum (NAS) registration request (referred to as mobility registration update) such that the correct RA can be configured to the UE. In 5G, RA also has the role to maintain allowed slices (alternatively, allowed NSSAI) of the UE. The allowed NSSAI is configured to the UE by the network. In the following description, the term “allowed S-NSSAI” refers to an S-NSSAI included in the allowed NSSAI. UE NAS can request access to an S-NSSAI and the network would decide to add that S-NSSAI to the UE's allowed NSSAI list or not.

Following SA2 and RAN3 agreements from Release 15, it has been agreed to have homogenous slice support within a TA, as well as homogenous support of the allowed slices within the RA of the UE. This means that the same slices are to be supported throughout a TA, and the allowed NSSAI is valid throughout the RA of the UE. In Release 18, the RA is expected to comprise multiple TAs that are not supporting all allowed slices of the UE (see the agreed SA2 SID work task #5 in SP-211641). In other words, it is expected that not each of the multiple TAs contained in the RA supports all of the allowed slices of the UE. This allows a more flexible registration area configuration. However, this relaxation may have a fundamental trade-off with paging mechanism.

According to embodiments of the present disclosure, there is providing a solution for paging in multi-cell camping. In particular, the present disclosure proposes a solution for an enhanced paging behavior in the scenario of non-homogenous slice support in a RA, or even in a TA.

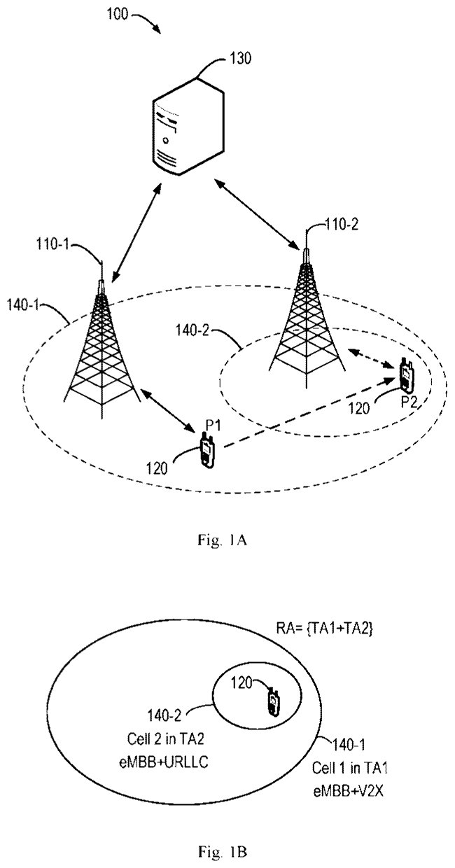

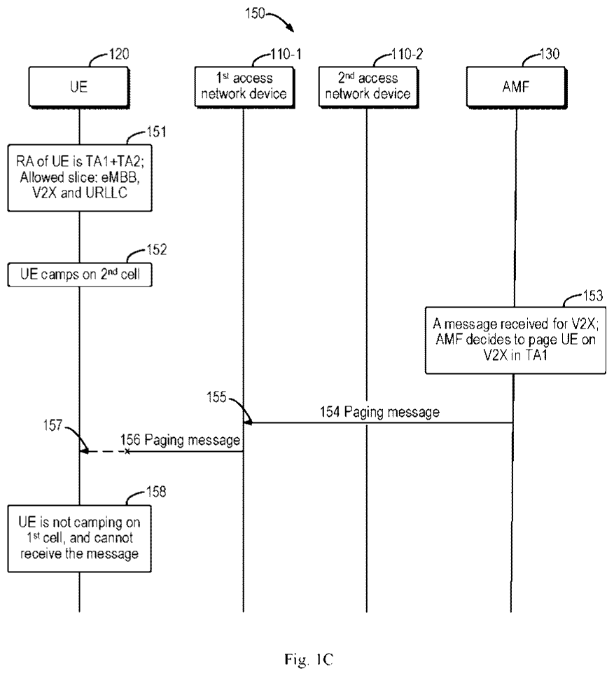

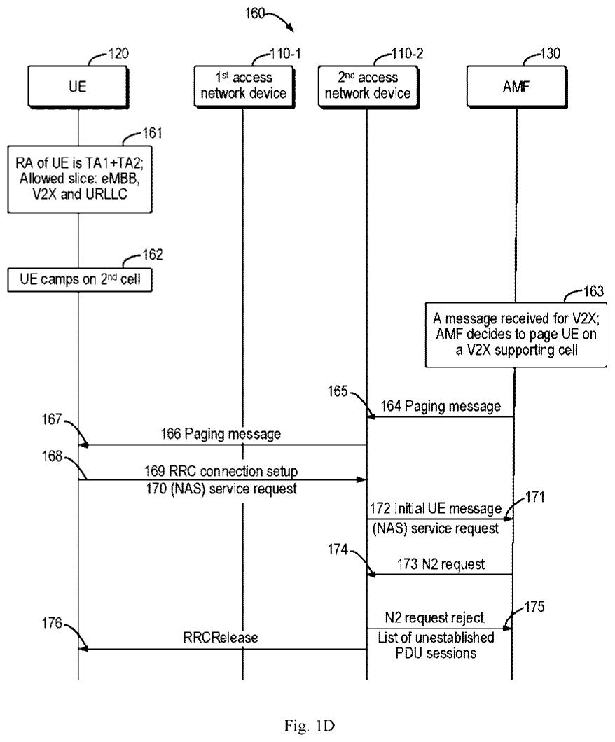

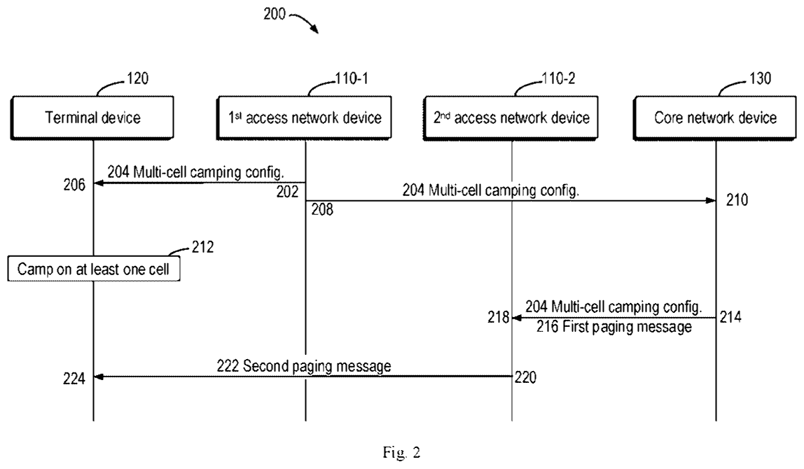

Principle and embodiments of the present disclosure will be described in detail below with reference to the accompanying drawings. Reference is first made to FIG. 1A, which illustrates an example communication system 100 in which embodiments of the present disclosure may be implemented. The communication system 100 includes a terminal device 120, a first access network device 110-1, a second access network device 110-2 (collectively referred to as access network devices 110 or network devices 110) and a core network device 130. The access network devices 110-1, 110-2 serve respective areas 140-1, 140-2 (also called as cells 140-1, 140-2). In some embodiments, the cells 140-1, 140-2 may be overlapped and use different frequency bands in both DL and UL to avoid interference. An access network device may support one or multiple (e.g., two, three, four, and the like) cells. Although each access network device 110 in FIG. 1A is illustrated as having a single associated cell, it will be appreciated that each access network device can also have multiple cells associated with different frequency carriers and bands. The terminal device 120 is capable of connecting and communicating in an UL and DL with the access network devices 110-1, 110-2 as long as the terminal device is located within the corresponding cells.

As shown in FIG. 1A, a communication link may be formed between the terminal device 120 located at the first position P1 and the first access network device 110-1. In some embodiments, the terminal device 120 may operate on a power saving mechanism including but not limited to DRX, eDRX, PSM, relaxed monitoring and so on. For example, in a DRX mechanism, the terminal device 120 may be released into an idle mode. In the idle mode UE will use a DRX cycle and as part of DRX cycle UE may wake up to monitor the Physical Downlink Control Channel (PDCCH) in order to detect the presence of a paging message. When the terminal device 120 is in an idle mode, the terminal device 120 may stay in the position P1, or move to other positions, e.g., the second position P2. The terminal device 120 may camp on one or more cells provided by the access network devices 110 e.g., based on the characteristics of the different cells currently accessible by the terminal device 120 and any requirements of the terminal device 120.

The communications between the terminal device 120 and the core network device 130 may be performed via one or more of the access network devices 110. The access network devices 110 may communicate with the core network device 130 and the core network device 130 may provide various services to the terminal devices 120 via the access network devices 110. In addition to communicating with the terminal device 120 and the core network device 130, the access network devices 110-1, 110-2 may also communicate with each other, for example, via a backhaul link.

It is to be understood that the number of access network devices, core network devices, cells and terminal devices is only for the purpose of illustration without suggesting any limitations. The system 100 may include any suitable number of access network devices, core network devices, cells and terminal devices adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As discussed above, in some scenarios, not each of the multiple TAs contained in the RA supports all of the allowed slices of the terminal device. FIG. 1B illustrates a schematic diagram of an example scenario of a non-homogenous network slice support in a RA. For the purpose of discussion, FIG. 1B will be described with reference to FIG. 1A. As shown in FIG. 1B, the terminal device 120 may be configured with a RA that comprises TA1 and TA2. Cells in TA1 (e.g., the first cell 140-1 provided by the first access network device 110-1) may support network slices for eMBB and V2X. Cells in TA2 (e.g., the second cell 140-2 provided by the second access network device 110-2) may support network slices for eMBB and URLLC. In some embodiments, the terminal device 120 may have allowed slices for eMBB, V2X and URLLC. The terminal device 120 may be assumed to be in an idle state and camping on the second cell 140-2. As discussed above, the relaxation of non-homogenous network slice support in a registration area may have a fundamental trade-off with paging mechanism.

FIG. 1C illustrates a schematic diagram of a paging procedure 150 in the scenario of FIG. 1B in a related solution. For the purpose of discussion, the process 150 will be described with reference to FIG. 1A and FIG. 1B. The process 150 may involve the terminal device 120 (also referred to as UE 120), the first access network device 110-1 providing the first cell 140-1, the second access network device 110-2 providing the second cell 140-2 and the core network device 130 (also referred to as access and mobility management function (AMF) 130) as illustrated in FIG. 1A.

As shown in FIG. 1C, at 151, the RA of the UE 120 is configured to include TA1 and TA2. The UE 120 may have allowed slices for eMBB, V2X and URLLC. At 152, the UE 120 is camping on the second cell 140-2 provided by the second access network device 110-2. At 153, AMF 130 may need to page the UE for V2X mobile terminated (MT) data. When the UE 120 is being paged for a protocol data unit (PDU) session of V2X, the AMF 130 transmits a paging message to the cells in TA1 which support V2X and decides to never transmit the paging message to any cells in TA2, since no cell of TA2 supports V2X. At 155, AMF 130 transmits the paging message 154 to the first access network device 110-1 which provides cells supporting V2X without transmitting the paging message 154 to the second access network device 110-2. At 157, the first access network device 110-1 transmits the paging message 156 to the UE 120 via the radio interface. At 158, since the UE 120 is camping on the second cell 140-2 but not the first cell 140-1, the UE 120 cannot receive the paging message 156.

If the radio coverages of the first and second cells 140-1 and 140-2 are overlapping (as shown in FIGS. 1A and 1B, e.g., in case of different frequency bands) and the UE 120 is under coverage of cell 1, the solution of FIG. 1C is a suboptimal behavior. However, the UE 120 cannot receive the paging message from the first cell 140-1 as it doesn't monitor paging occasions from the first cell 140-1 when the UE is camping on the second cell 140-2. Current standard behavior that is the UE monitors paging occasion only from the single cell that it is camping in the same public land mobile network (PLMN).

FIG. 1D illustrates a schematic diagram of a paging procedure 160 in the scenario of FIG. 1B in another related solution. For the purpose of discussion, the process 160 will be described with reference to FIG. 1A and FIG. 1B. The process 160 may involve the terminal device 120 (also referred to as UE 120), the first access network device 110-1 providing the first cell 140-1, the second access network device 110-2 providing the second cell 140-2 and the core network device 130 (also referred to as AMF 130) as illustrated in FIG. 1A.

As shown in FIG. 1D, at 161, the RA of the UE 120 is configured to include TA1 and TA2. The UE 120 may have allowed slices for eMBB, V2X and URLLC. At 162, the UE 120 is camping on the second cell 140-2 provided by the second access network device 110-2. At 163, AMF 130 may need to page the UE for V2X MT data. When the UE 120 is being paged for a PDU session of V2X, the AMF 130 may page the whole RA which includes cells not supporting V2X. At 165, AMF 130 transmits the paging message 164 to all the access network devices in the RA of the UE. In particular, the second access network device 110-2 may receive the paging message 164 as the second cell 140-2 is in the RA of the UE 120. At 167, the first access network device 110-1 transmits the paging message 166 to the UE 120 via the radio interface. At 168, the UE 120 transmits a radio resource control (RRC) connection setup request 169 and a service request 170 to the second access network device 110-2. At 171, the second access network device 110-2 transmits the service request and an initial UE message 172 to the AMF 130. At 174, the AMF 130 transmits a N2 request 173 for the V2X MT data to the second access network device 110-2. At 175, since the second cell 140-2 provided by the second access network device 110-2 doesn't support the slice for V2X, the second access network device 110-2 rejects the service request. A list of unestablished PDU sessions may thus be transmitted to the AMF 130. At 176, the UE 120 is released as it cannot initiate any PDU session.

In a further related solution, the AMF 130 may be aware of the overlapping coverage of different cells and may page the UE 120 over the non-slice supporting cell (e.g., the second cell 140-2) to be re-directed to the slice supporting cell (e.g., the first cell 140-1). Theses related solutions require the UE to either go to a RRC connected mode or to initiate RRC connection setup to be guided to the correct cell, which introduces processing load on the RAN node and delay in the service access of the UE.

In this disclosure, a solution is provided to enable an enhanced paging behavior without homogenous slice support requirements in a RA of the UE, or even in a TA. This will be described in connection with FIGS. 2-9.

FIG. 2 shows a process 200 for paging in multi-cell camping according to an embodiment of the present disclosure. For the purpose of discussion, the process 200 will be described with reference to FIG. 1A. The process 200 may involve the terminal device 120, the first access network device 110-1, the second access network device 110-2 and the core network device 130 as illustrated in FIG. 1A. It would be appreciated that although the process 200 has been described in the communication system 100 of FIG. 1A, this process may be likewise applied to other communication scenarios.

In the process 200, the first access network device 110-1 transmits (202) a multi-cell camping configuration 204 to the terminal device 120. The multi-cell camping configuration 204 is indicative of a plurality of paging configurations for the terminal device 120 to monitor paging occasions from a set of cells. A cell among the set of cells supports at least one of a set of allowed slices of the terminal device. The terminal device 120 receives (206) the multi-cell camping configuration 204 from the first access network device 110-1. The first access network device 110-1 transmits (208) the multi-cell camping configuration 204 to the core network device 130. The core network device 130 receives (210) the multi-cell camping configuration 204 from the first access network device 110-1. It will be appreciated that the sequential order of transmissions of the multi-cell camping configuration 204 to the terminal device 120 and to the core network device 130 is not restrictive and can be performed in the opposite order to that shown in FIG. 2, or can be performed simultaneously.

The terminal device 120 may be released to an idle mode. Based on the multi-cell camping configuration 204, the terminal device 120 camps (212) on at least one cell among the set of cells. The core network device 130 transmits (214), to the second access network device 110-2, the multi-cell camping configuration 204 and a first paging message 216 for the terminal device 120. The first paging message 216 is associated with an allowed slice among the set of allowed slices. In the following description, the allowed slice associated with the paging message 216 may be also referred to as a first slice.

The second access network device 110-2 receives (218) the multi-cell camping configuration 204 and the first paging message 216 from the core network device 130. Based on the multi-cell camping configuration, the second access network device 110-2 transmits (220) a second paging message 222 associated with the first slice to the terminal device 120 from a cell supporting the first slice. In other words, the second paging message 222 may be transmitted over cells that support the first slice and would not be transmitted over cells that do not support the first slice. Based on the multi-cell camping configuration 204, the terminal device 120 receives (224) the second paging message 222 from one of the at least one cell. The cell of the at least one cell supports the first slice. In this way, an enhanced paging scheme without homogenous slice support requirements in RA or even in a TA may be provided.

In some embodiments, the plurality of paging configurations in the multi-cell camping configuration 204 may be slice-specific. For example, based on a paging configuration corresponding to an allowed slice of the terminal device 110, the terminal device 120 may monitor a set of paging occasions from a cell supporting said allowed slice and access network devices in the RA may transmit paging messages, if any, over cells supporting said allowed slice at the paging occasions corresponding to the allowed slice.

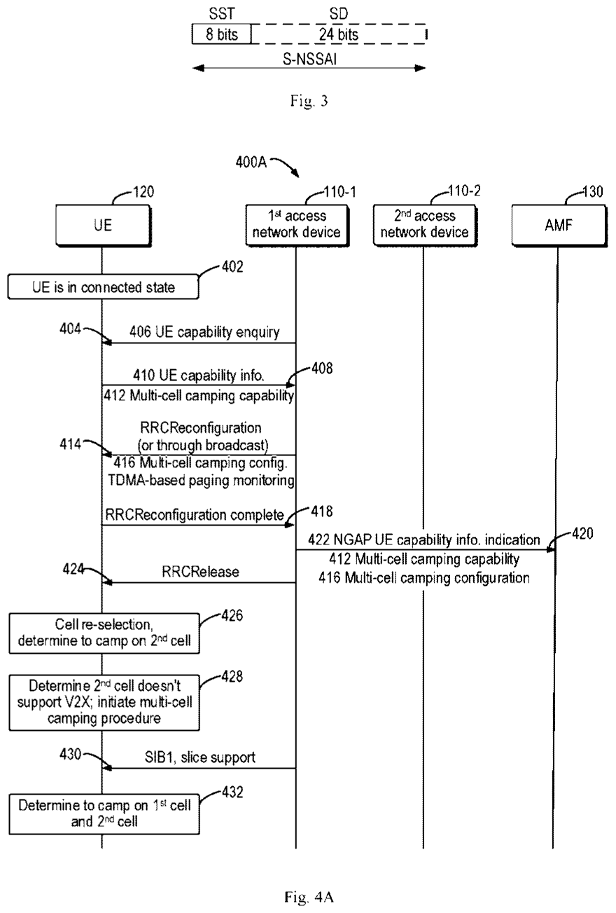

In some embodiments, the multi-cell camping configuration 204 may contain a network slice scope, e.g., a list of S-NSSAIs, mapped to the plurality of paging configurations. FIG. 3 illustrates a schematic diagram of a format of a S-NSSAI according to current specifications. As shown in FIG. 3, the S-NSSAI may include both Slice Service Type (SST) field and Slice Differentiator (SD) field with a total length of 32 bits or include only SST field part in which case the length of S-NSSAI is 8 bits only. The SST field may have standardized and non-standardized values. Values 0 to 127 belong to the standardized SST range. For instance, SST value of 1 may indicate that the slice is suitable for handling of 5G eMBB, SST value of 2 may indicate that the slice is suitable for handling of URLLC, etc. SD is operator-defined only.

Turning back to FIG. 2, although the core network device 130 is illustrated to transmit the first paging message 216 to only one access network device, it will be appreciated that the core network device 130 may transmit the first paging message 216 to multiple access network devices since the core network device 130 is not aware of the location of the terminal device 120 in the RA. In addition, it will be appreciated that multiple access network devices may transmit the second paging message 222 to the terminal device 120 from multiple cells supporting the first slice based on the multi-cell camping configuration 204.

In some embodiments, when transmitting the first paging message 216 to the second access network device 110-2, the core network device 130 may determine whether the second access network device 110-2 supports the first slice. If the second access network device 110-2 supports the first slice, the core network device 130 transmit the first paging message 216 to the second access network device 110-2. In other words, the core network device 130 may transmit the first paging message 216 only to access network devices in the RA that provide cells supporting the first slice. Alternatively, the core network device 130 may transmit the first paging message 216 together with the slice ID of the first slice to all access network devices in the RA. Based on the slice ID of the first slice, the access network devices may transmit the second paging message 222 only over cells supporting the first slice. In this way, cells that don't support the first slice would not transmit the paging message associated with the first slice and thus RRC connection setup would not be initiated between cells that don't support the first slice and the terminal device. In this manner, radio resource expense may be reduced and latency in the service access of the terminal device may be decreased.

In some embodiments, prior to transmitting the multi-cell camping configuration 204 to the terminal device 120 and to the core network device 130, the first access network device 110-1 may receive, from the terminal device 120, an indication indicative of a multi-cell camping capability of the terminal device 120. In some embodiments, the indication may indicate whether or not the terminal device 120 is capable of camping on multiple cells. Alternatively or additionally, the indication may indicate whether or not the terminal device 120 is capable of camping on different cells at different radio frame sets. Alternatively or additionally, the indication may indicate whether or not the terminal device 120 is capable of camping on different cells over different radio frequencies. Alternatively or additionally, the indication may indicate whether or not the terminal device 120 is capable of camping on different cells with different reception beams. In this way, the multi-cell camping configuration may be determined based on the multi-cell camping capability of the terminal device.

In some embodiments, the plurality of paging configurations may include a plurality of radio frame sets. The terminal device 120 may be indicated to camp on one of the set of cells at one of the plurality of radio frame sets. Alternatively or additionally, the plurality of paging configurations may include a plurality of radio frequencies. The terminal device 120 may be indicated to camp on one of the set of cells over one of the plurality of radio frequencies. Alternatively or additionally, the plurality of paging configurations may include a plurality of reception beams. The terminal device 120 may be indicated to camp on one of the set of cells over one of the plurality of reception beams. In this way, the flexibility of the camping configuration of the terminal device may be improved.

In some embodiments, the plurality of paging configurations may comprise information of a radio frame set for a subset of cells among the set of cells. The subset of cells may support the first slice. When transmitting the second paging message 222 to the terminal device 120, the second access network device 110-2 may determine whether a radio frame is in the radio frame set. For example, the radio frame is a paging frame from which the terminal device 120 monitors the paging message. If the radio frame is not in the radio frame set, the second access network device 110-2 may determine not to transmit the second paging message 222 to the terminal device 120. If the radio frame is in the radio frame set, the second access network device 110-2 may transmit the second paging message 222 to the terminal device 120.

In some embodiments, the terminal device 120 may camp on multiple cells. For example, the at least one cell that the terminal device 120 camps on may comprise the first cell 140-1 and the second cell 140-2. When the terminal device 120 is in an idle mode, the terminal device 120 may determine to camp on the first cell 140-1, e.g., through a cell re-selection procedure. If the first cell 140-1 does not support all of the set of allowed slices of the terminal device 120, the terminal device 120 may initiate a multi-cell camping procedure and select other cells that support the slices among the set of allowed slices that the first cell 140-1 does not support. The terminal device 120 may determine that the first cell 140-1 and the second cell 140-2 support all of the set of allowed slices of the terminal device. The terminal device 120 may then camp on the first cell 140-1 and the second cell 140-2 based on the multi-cell camping configuration 204. It will be appreciated that the terminal device 120 may also camp on more than two cells. In this way, latency in the service access of the terminal device may be reduced.

In some embodiments, in order to transmit the multi-cell camping configuration 204 to the terminal device 120, the first access network device 110-1 may transmit a RRCReconfiguration message including the multi-cell camping configuration to the terminal device 120. Alternatively, in order to transmit the multi-cell camping configuration 204 to the terminal device 120, the first access network device 110-1 may transmit a broadcast message including the multi-cell camping configuration to the terminal device 120. In some embodiments, in order to transmit the multi-cell camping configuration 204 to the core network device 130, the first access network device 110-1 may transmit a next generation application protocol (NGAP) UE radio capability information indication including the multi-cell camping configuration to core network device 130. Alternatively, in order to transmit the multi-cell camping configuration 204 to the core network device 130, the first access network device 110-1 may transmit a NGAP message associated with context of the terminal device 120, for example, an UE context release request including the multi-cell camping configuration to the core network device 130.

In some embodiments, the first paging message 216 may include the multi-cell camping configuration 204. In other words, in order to transmit the multi-cell camping configuration 204 and the first paging message 216 to the second access network device 110-2, the core network device 130 may transmit the first paging message 216 including the multi-cell camping configuration 204. Alternatively, the core network device 130 may transmit the first paging message 216 and the multi-cell camping configuration 204 separately in the same transmission. Alternatively, the core network device 130 may transmit the first paging message 216 and the multi-cell camping configuration 204 separately in the two transmissions. For example, in order to transmit the multi-cell camping configuration 204 and the first paging message 216 to the second access network device 110-2, the core network device 130 may transmit the multi-cell camping configuration 204 to the second access network device 110-2 and then transmit the first paging message 216 to the second access network device 110-2. In some embodiments, the first paging message 216 may be a NGAP paging message. The second paging message 222 may be a RRC paging message.

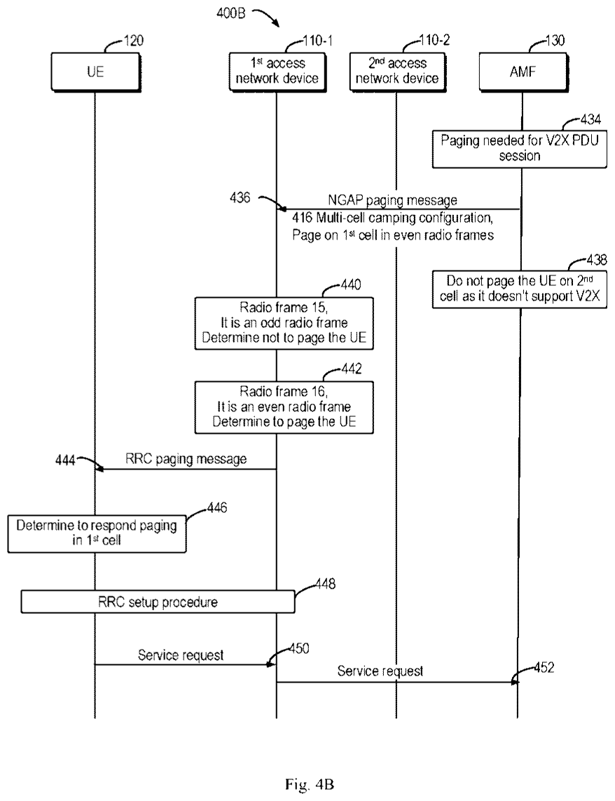

FIGS. 4A and 4B illustrates an example of processes 400A and 400B for paging in multi-cell camping in accordance with some example embodiments of the present disclosure. It is noted that the process 400B is a continuation of the process 400A and the processes 400A and 400B can be considered as a more specific example of the process 200 of FIG. 2. For the purpose of discussion, the process 160 will be described with reference to FIG. 1A and FIG. 1B. The process 160 may involve the terminal device 120 (also referred to as UE 120), the first access network device 110-1 providing the first cell 140-1, the second access network device 110-2 providing the second cell 140-2 and the core network device 130 (also referred to as AMF 130) as illustrated in FIG. 1A. It is to be understood that processes 400A and 400B may further include additional blocks not shown and/or omit some shown blocks, and the scope of the present disclosure is not limited in this regard.

In the process 400A, at 402, the UE 120 is in RRC connected mode in the first cell 140-1 provided by the first access network device 110-1. The first cell 140-1 may be referred to as the serving cell. The UE 120 may have allowed slices for eMBB, V2X and URLLC. The UE 120 may be configured with a RA that comprises TA1 and TA2. The first cell 140-1 in TA1 may support network slices for eMBB and V2X. The second cell 140-2 provided by the second access network device 110-2 in TA2 may support network slices for eMBB and URLLC. At 404, the first access network device 110-1 may transmit an UE capability enquiry 406 to the UE 120 via the first cell 140-1. After receiving the UE capability enquiry 406, the UE 120 may answer the first access network device 110-1 with UE capability information 410 at 408. For example, the UE 120 may indicate a capability 412 for multi-cell camping. Alternatively, the first access network device 110-1 may receive the UE capability information from another network node in the same way as it receives other capability information of the UE 120.

At 414, the first access network device 110-1 may configure the UE 120 with a multi-cell camping configuration 416. The first access network device 110-1 may transmit the multi-cell camping configuration 416 to the UE 120 in a RRCReconfiguration or through broadcast. The multi-cell camping configuration 416 may comprise a slice specific TDMA schedule for the UE 120 to camp on a cell supporting a list of slices, for e.g., two radio frames, and to camp on another cell supporting another list of slices for, e.g., another two radio frames. In some embodiments, the TDMA schedule may also be for different frequency bands instead of slice specific. Alternatively, the multi-cell camping configuration 416 may comprise a schedule for the UE 120 to camp on different cells at different frequencies at the same time, e.g., when the UE 120 has multiple reception chains. Alternatively, the multi-cell camping configuration 416 may comprise a slice specific schedule for the UE 120 to camp on different cells over different reception beams, e.g., when the UE 120 is a multi-panel UE. The multi-cell camping configuration 416 may be determined by the first access network device 110-1 based on the multi-cell camping capability 412 of the UE 120. At 418, the UE 120 may acknowledge the multi-cell camping configuration 416.

At 420, the first access network device 110-1 may indicate the multi-cell camping capability 412 to the AMF 130 through an NGAP UE capability information indication message 422. Moreover, the first access network device 110-1 may inform the AMF 130 about the multi-cell camping configuration 416 (e.g. the TDMA schedule). Alternatively, the first access network device 110-1 may indicate the multi-cell camping capability 412 and the multi-cell camping configuration 416 of the UE 120 through a NGAP message associated with context of the terminal device 120, for example, an UE context release request. The multi-cell camping capability 412 and the multi-cell camping configuration 416 may be stored in the AMF 130. At 424, the UE 120 may be released into an idle mode and the first access network device 110-1 may release the UE context, including the multi-cell camping capability 412 and the multi-cell camping configuration 416 of the UE 120.

At 426, the UE 120 in an idle mode may perform a cell re-selection procedure. In the cell re-selection procedure, the UE 120 may determine that the second cell 140-2 provided by the second access network device 110-2 is the best ranked suitable cell, and thus determine to camp on the second cell 140-2. At 428, the UE 120 may determine whether the second cell 140-2 supports all the allowed slices for the UE 120. For example, the UE 120 may determine that the second cell 140-2 doesn't support V2X. The determination may be based on slice specific cell re-selection information that indicates a network slice access group (NSAG) support for the TA granularity or cell level granularity. This determination may trigger a multi-cell camping procedure. The multi-cell camping procedure allows the UE 120 to camp on multiple cells which, as a whole, provide support for each of the allowed, configured and active PDU session slices of the UE 120. In multi-cell camping procedure, the UE 120 may perform a cell search to find a suitable cell (as defined in 38.304) that supports V2X. Through the multi-cell camping procedure, the UE 120 may find the first cell 140-1 provided by the first access network device 110-1.

At 430, the UE 120 may acquire SIBI of the first cell 140-1 and determine that the first cell 140-1 supports V2X slice as indicated at 428. At 432, the UE 120 may start camping on the first cell 140-1 in addition to the second cell 140-2 based on the previously configured multi-cell camping configuration 416 (e.g. the TDMA schedule). In an exemplary embodiment, based on the TDMA schedule in the multi-cell camping configuration 416, the UE 120 may camp on the first cell 140-1 in even radio frames and camp on the second cell 140-2 in odd radio frames. The determination of even or odd radio frames is an exemplary mathematical operation to differentiate paging frames between RAN nodes. Another example can be subjecting the radio frame number to a modulo two operation.

Reference is now made to FIG. 4B. At 434, the AMF 130 may determine to page the UE 120. For example, the AMF 130 may receive a paging request related to a PDU session of a V2X slice. At 436, the AMF 130 may page access network devices that provide cells supporting the V2X slice in the RA of the UE 120. In the following description, the cells supporting the slice associated with the PDU session may be referred to as a first subset of cells and the cells not supporting the slice associated with the PDU session may be referred to as a second subset of cells. It would be appreciated that the first cell 140-1 belongs to the first subset of cells as it supports the V2X slice and the second cell 140-2 belongs to the second subset of cells as it doesn't support the V2X slice. The UE radio capability for paging may be included in a NGAP paging message with the slice ID of the V2X slice. Based on the NGAP paging message received from the AMF 130, each access network device may select cells relevant for the included slice ID and determine the corresponding paging radio frames and paging occasions. For example, the AMF 130 may transmit the previously stored multi-cell camping configuration 416 to access network devices that provide the first subset of cells in the RA. The access network devices that provide the first subset of cells in the RA may transmit RRC paging messages to the UE 120 based on the multi-cell camping configuration 416. At 438, the AMF 130 may determine not to page the UE 120 on the second subset of cells since the second subset of cells doesn't support the V2X slice associated with the PDU session.

Alternatively, the AMF 130 may page all access network devices in the RA of the UE 120. The UE radio capability for paging may be included in a NGAP paging message with the slice ID associated with the PDU session. Based on the NGAP paging message received from the AMF 130, each access network device may select cells relevant for the included slice ID and determine the corresponding paging radio frames and paging occasions. Since the second subset of cells doesn't support the V2X slice associated with the PDU session, the second subset of cells would determine not to page the UE 120.

Based on the TDMA schedule in the multi-cell camping configuration 416, the access network devices that provide the first subset of cells may determine to page the UE 120 in even radio frames on the first subset of cells and not to page the UE 120 in odd radio frames. At 440, at radio frame 15, the access network devices that provide the first subset of cells may determine that radio frame 15 is an odd radio frame and thus determine not to page the UE 120. At 442, at radio frame 16, the access network devices that provide the first subset of cells may determine that radio frame 16 is an even radio frame and thus determine to page the UE 120. At 444, the access network devices that provide the first subset of cells may transmit RRC paging messages to the UE 120. As the UE 120 camps on the first cell 140-1 in even radio frames, the UE 120 may receive the RRC paging message from the first cell 140-1 belonging to the first subset of cells. At 446, the UE 120 may determine to respond to the paging over the first cell 140-1. At 448, the UE 120 may initiate a RRC setup procedure with the first cell 140-1. At 450, the UE 120 in a connected mode may transmit a service request to the first access network device 110-1 over the first cell 140-1. At 452, the first access network device 110-1 may forward the service request to the AMF 130.

The UE 120 is a multi-slice UE. In scenarios where not all slices (allowed or configured or with active PDU session) of the UE 120 are supported over the cell that the UE 120 is camping on, the UE 120 may initiate a multi-cell camping procedure. The multi-cell camping may be applied to enable the UE to camp on at least two cells in different frequency bands. In some embodiments, if enhanced PHY techniques are used to limit interference, e.g., when the UE 120 is a multi-panel UE, the UE 120 may camp on multiple cells in the same frequency as well. The multi-cell camping procedure may enable the UE 120 to camp on multiple cells, offering different slice support of the allowed, configured or with active PDU session s-NSSAI of the UE 120.

In some embodiments, the multi-cell camping capability of the UE 120 may be sent by the UE 120 as part of the capability information and within the UE Radio capability for paging information element (IE). Alternatively, the network may know the multi-cell camping capability of the UE 120 from the International Mobile Equipment Identifier (IMEI) (model) of the UE 120. Multi-cell camping capability of the UE 120 may be stored in the UE Radio capability for paging IE in the AMF 130. The AMF 130 may include this UE Radio capability for paging IE in the NGAP Paging message and the paged gNB may thus learn whether the UE is supporting multi-cell camping.

In some embodiments, AMF 130 may transmit a NGAP Paging message to the whole RA of the UE along with the slice ID and UE Radio capability for paging IE and the gNBs may restrict the radio paging to those cells which support the slice relevant for paging, e.g., the PDU session triggering the paging. Alternatively, the AMF 130 may transmit the NGAP Paging message to gNBs that provide cells supporting the slice relevant for paging and not transmit to gNBs that don't provide cells supporting the slice relevant for paging.

Table 1 shows the UE Radio capability for paging IE at 9.3.1.68 in TS 38.413. The UE Radio capability for paging IE contains paging specific UE Radio Capability information.

TABLE 1
UE Radio capability for paging IE at 9.3.1.68 in TS 38.413

| | | | | |
|---|---|---|---|---|
| | | | IE type | |
| IE/Group | Pres- | | and | |
| Name | ence | Range | reference | Semantics description |

| | | | |
|---|---|---|---|
| UE Radio | O | OCTET | Includes the RRC |
| Capability | | STRING | UERadioPagingInformation |
| for Paging | | | message as defined in TS |
| of NR | | | 38.331 [18]. |
| UE Radio | O | OCTET | Includes the RRC |
| Capability | | STRING | UERadioPagingInformation |
| for Paging | | | message as defined in TS |
| of E-UTRA | | | 36.331 [21]. |
| UE Radio | O | OCTET | Includes the RRC |
| Capability | | STRING | UERadioPagingInformation- |
| for Paging | | | NB message as defined in |
| of NB-IoT | | | TS 36.331 [21]. |

Table 2 shows the UE Radio capability for paging IE at 9.2.3.91 in TS 38.423. The UE Radio capability for paging IE contains paging specific UE Radio Capability information.

TABLE 2
UE Radio capability for paging IE at 9.2.3.91 in TS 38.423

| | | | | |
|---|---|---|---|---|
| | | | IE type | |
| IE/Group | Pres- | | and | |
| Name | ence | Range | reference | Semantics description |

| | | | |
|---|---|---|---|
| UE Radio | O | OCTET | Includes the RRC |
| Capability for | | STRING | UERadioPagingInformation |
| Paging of NR | | | message as defined in TS |
| | | | 38.331 [18]. |
| UE Radio | O | OCTET | Includes the RRC |
| Capability for | | STRING | UERadioPagingInformation |
| Paging of E- | | | message as defined in TS |
| UTRA | | | 36.331 [21]. |

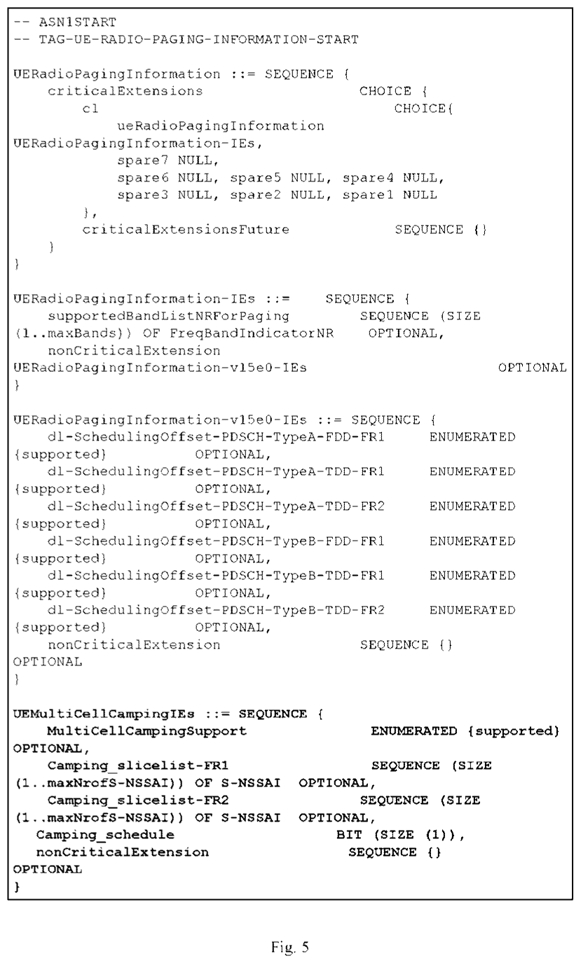

FIG. 5 illustrates an exemplary UERadioPagingInformation message in accordance with some example embodiments of the present disclosure. The bolded part in FIG. 5 may indicate the information to be added to UERadioPagingInformation message in TS 38.331. The MultiCellCampingSupport IE indicates the support of the capability. The Camping_slicelist IE indicates a list of slices of the UE for which UE camps a specific frequency with high priority. The Camping_schedule IE is a binary flag indicating that for “0” value, UE would be camping on FR1 on even system frames numbers (SFNs) and for “1” value, UE would be camping on FR2 for even SFNs. The granularity of the bitmap may be for each subframe in a radio frame.

The network may coordinate paging parameters through implementation to enable multi-cell paging. These paging parameters may be used by a UE to determine an identifier for a paging frame and an identifier for a paging occasion. A paging occasion (PO) is a subframe that may possibly include a paging message. A paging frame (PF) is a radio frame that may contain one or more paging occasions. Knowledge of both a System Frame Number (SFN) for the PF and the Subframe Number (or index) for the PO allows the UE to know the exact timing when the UE is required to wake up to check for a paging message. However, it is not clear how the coordination would work in a multi-vendor scenario. In an exemplary but non-limiting implementation, the PF and PO for paging are determined by the following formulae:

SFN for the PF may be determined by the equation (1):

$$( SFN + PF\_offset ) mod T = ( T div N ) * ( UE\_ID mod N ) \qquad ( 1 )$$

Index (i_s), indicating the index of the PO is determined by the equation (2):

$$i\_s = floor ( UE\_ID / N ) mod Ns . \qquad ( 2 )$$

The parameter T is the DRX cycle of the UE. The parameter T is determined by the minimum of (a) the UE specific DRX value(s), if configured by RRC and/or upper layers, and (b) a default DRX value broadcast in system information. In RRC_IDLE state, if UE specific DRX is not configured by upper layers, the default value is applied.

The parameter N is the number of total paging frames in T. The parameter Ns is the number of paging occasions for a PF. The parameter PF_offset is the offset used for PF determination. The parameter UE_ID is determined by the equation: UE_ID=IMSI mod 1024, where IMSI (International Mobile Subscriber Identity) is in decimal format and stored in the USIM (Universal Subscriber Identity Module) of the UE.

Parameters N, Ns and PF_Offset are all cell specific. Network must page in multiple cells for all POs that UE monitors in the multiple cells. In case network aims to use paging resources efficiently, the network should coordinate POs of the UE among the multiple cells. For this reason, the network should disable the UE from camping one cell for a duration of DRX cycle.

For example, the UE may have two allowed slices, e.g., a slice with FR1 and another slice with FR2. Once the SFN is calculated, the RAN node shall apply to following equation (3) to decide to page the UE:

$$Z = floor ( ( ( SFN ) mod T * 2 ) / T ) . \qquad ( 3 )$$

If Z=Camping_schedule, the RAN Nodes with FR1 should page the UE while the RAN Nodes with FR2 should not page the UE. If Z not equal to Camping_schedule, the RAN Nodes with FR2 should page the UE while the RAN Nodes with FR1 should not page the UE.

In an exemplary but non-limiting example, a DRX cycle is 32, N and PF offset are 8, Camping_schedule=1.

$$( S F N + 8 ) mod 32 = ( 32 div 8 ) * ( 100 mod 8 ) .$$

The system frames numbers where the UE is paged are [8, 40, 72].

With the multi-cell camping:

At SFN=8, Z=floor (((8 mod 32*2)/32)=0. Z is not equal to Camping_schedule, so RAN Nodes with FR2 should page the UE while RAN Nodes with FR1 should not page the UE.

At SFN=40, Z=floor (((40 mod 32*2)/32)=1. Z is equal to Camping_schedule, so RAN Nodes with FR1 should page the UE while RAN Nodes with FR2 should not page the UE.

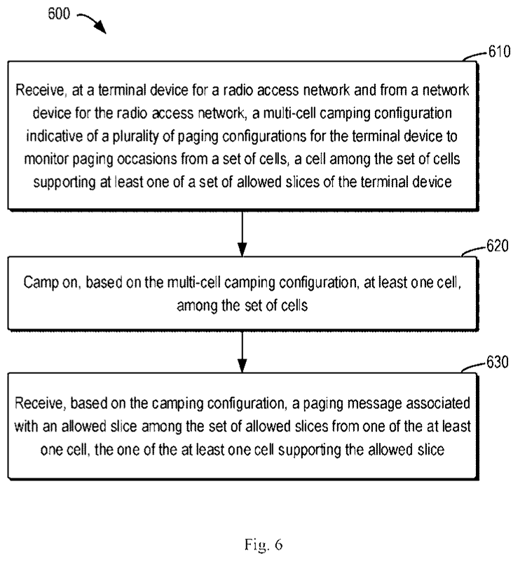

FIG. 6 shows a flowchart of an example method 600 implemented at a terminal device in accordance with some embodiments of the present disclosure. For the purpose of discussion, the method 600 will be described from the perspective of the terminal device 120 with reference to FIG. 1A.

At block 610, the terminal device 120 for a radio access network receives, from a network device 110-1 for the radio access network, a multi-cell camping configuration indicative of a plurality of paging configurations for the terminal device 120 to monitor paging occasions from a set of cells. A cell among the set of cells supports at least one of a set of allowed slices of the terminal device 120. At block 620, the terminal device 120 camps on at least one cell among the set of cells based on the multi-cell camping configuration. At block 630, based on the multi-cell camping configuration, the terminal device 120 receives a paging message associated with an allowed slice among the set of allowed slices from one of the at least one cell. The one of the at least one cell supports the allowed slice.

In some embodiments, prior to receiving the multi-cell camping configuration, the terminal device 120 may transmit, to the network device 110-1, an indication indicative of a multi-cell camping capability of the terminal device 120. In some embodiments, the multi-cell camping capability may comprise a capability of camping on different cells at different radio frame sets. Alternatively or additionally, the multi-cell camping capability may comprise a capability of camping on different cells over different radio frequencies. Alternatively or additionally, the multi-cell camping capability may comprise a capability of camping on different cells with different reception beams.

In some embodiments, the plurality of paging configurations may comprise a plurality of radio frame sets, the terminal device being indicated to camp on one of the set of cells at one of the plurality of radio frame sets. Alternatively or additionally, the plurality of paging configurations may comprise a plurality of radio frequencies, the terminal device being indicated to camp on one of the set of cells over one of the plurality of radio frequencies. Alternatively or additionally, the plurality of paging configurations may comprise a plurality of reception beams, the terminal device being indicated to camp on one of the set of cells over one of the plurality of reception beams.

In some embodiments, the at least one cell may comprise a first cell and at least one second cell. In order to camp on the at least one cell, the terminal device 120 may camp on the first cell based on determining that the terminal device is in an idle mode. Based on determining that the first cell does not support all of the set of allowed slices of the terminal device, the terminal device 120 may determine that the first cell and the at least one second cell support all of the set of allowed slices of the terminal device. The terminal device 120 may camp on the at least one second cell based on the multi-cell camping configuration.

In some embodiments, in order to receive the multi-cell camping configuration, the terminal device 120 may receive a RRCReconfiguration message comprising the multi-cell camping configuration from the network device 110-1. Alternatively, in order to receive the multi-cell camping configuration, the terminal device 120 may receive a broadcast message comprising the multi-cell camping configuration from the network device 110-1.

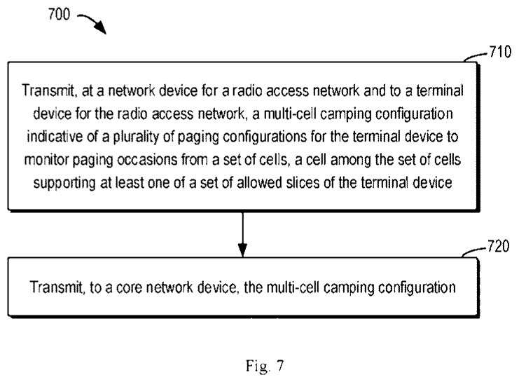

FIG. 7 shows a flowchart of an example method 700 implemented at a network device in accordance with some embodiments of the present disclosure. For the purpose of discussion, the method 700 will be described from the perspective of the first network device 110-1 with reference to FIG. 1A.

At block 710, the first network device 110-1 transmits, to a terminal device 120 for the radio access network, a multi-cell camping configuration indicative of a plurality of paging configurations for the terminal device 120 to monitor paging occasions from a set of cells. A cell among the set of cells supports at least one of a set of allowed slices of the terminal device 120. At 720, the first network device 110-1 transmits the multi-cell camping configuration to a core network device 130.

In some embodiments, prior to transmitting the multi-cell camping configuration 204 to the terminal device 120, the first network device 110-1 may receive, from the terminal device 120, an indication indicative of a multi-cell camping capability of the terminal device 120. In some embodiments, the multi-cell camping capability may comprise a capability of camping on different cells at different radio frame sets. Alternatively or additionally, the multi-cell camping capability may comprise a capability of camping on different cells over different radio frequencies. Alternatively or additionally, the multi-cell camping capability may comprise a capability of camping on different cells with different reception beams.

In some embodiments, the plurality of paging configurations may comprise a plurality of radio frame sets, the terminal device being indicated to camp on one of the set of cells at one of the plurality of radio frame sets. Alternatively or additionally, the plurality of paging configurations may comprise a plurality of radio frequencies, the terminal device being indicated to camp on one of the set of cells over one of the plurality of radio frequencies. Alternatively or additionally, the plurality of paging configurations may comprise a plurality of reception beams, the terminal device being indicated to camp on one of the set of cells over one of the plurality of reception beams.

In some embodiments, in order to transmit the multi-cell camping configuration to the terminal device 120, the first network device 110-1 may transmit a RRCReconfiguration message comprising the multi-cell camping configuration. Alternatively, in order to receive the multi-cell camping configuration, the first network device 110-1 may transmit a broadcast message comprising the multi-cell camping configuration.

In some embodiments, in order to transmit the multi-cell camping configuration to the core network device 130, the first network device 110-1 may transmit a NGAP UE radio capability information indication comprising the multi-cell camping configuration. Alternatively, in order to receive the multi-cell camping configuration, the first network device 110-1 may transmit a NGAP message associated with context of the terminal device 120 comprising the multi-cell camping configuration.

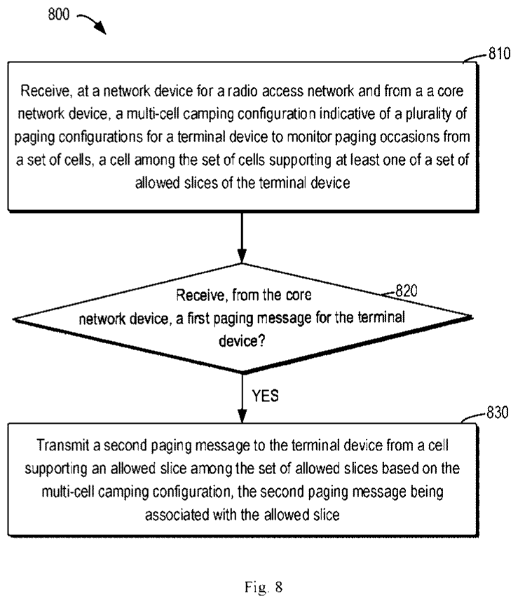

FIG. 8 shows a flowchart of an example method 800 implemented at a network device in accordance with some embodiments of the present disclosure. For the purpose of discussion, the method 800 will be described from the perspective of the network device 110 (e.g., the first network device 110-1, the second network device 110-2) with reference to FIG. 1A.

At block 810, the network device 110 receives, from a core network device 130, a multi-cell camping configuration indicative of a plurality of paging configurations for a terminal device 120 to monitor paging occasions from a set of cells. A cell among the set of cells supports at least one of a set of allowed slices of the terminal device. At 820, the network device 110 determines whether the network device 110 receives a first paging message for the terminal device 120 from the core network device 130. Based on receiving the first paging message for the terminal device 120 from the core network device 130, at 830, the network device 110 transmits a second paging message to the terminal device 120 from a cell supporting an allowed slice among the set of allowed slices based on the multi-cell camping configuration. The second paging message is associated with the allowed slice.

In some embodiments, the plurality of paging configurations may comprise a plurality of radio frame sets, the terminal device being indicated to camp on one of the set of cells at one of the plurality of radio frame sets. Alternatively or additionally, the plurality of paging configurations may comprise a plurality of radio frequencies, the terminal device being indicated to camp on one of the set of cells over one of the plurality of radio frequencies. Alternatively or additionally, the plurality of paging configurations may comprise a plurality of reception beams, the terminal device being indicated to camp on one of the set of cells over one of the plurality of reception beams.

In some embodiments, the plurality of paging configurations may comprise a radio frame set for a subset of cells among the set of cells. The subset of cells may support the allowed slice. In order to transmit the second paging message to the terminal device 120, the network device 110 may determine whether a radio frame is in the radio frame set. Based on determining that the radio frame is not in the radio frame set, the network device 110 may determine not to transmit the second paging message to the terminal device 120. Based on determining that the radio frame is in the radio frame set, the network device 110 may determine to transmit the second paging message to the terminal device 120.

In some embodiments, when receiving the multi-cell camping configuration, the network device 110 may receive the multi-cell camping configuration together with the first paging message from the core network device 130. In some embodiments, when receiving the multi-cell camping configuration, the network device 110 may receive the first paging message comprising the multi-cell camping configuration from the core network device 130. In some embodiments, the first paging message may be a NGAP paging message, and the second paging message may be a RRC paging message.

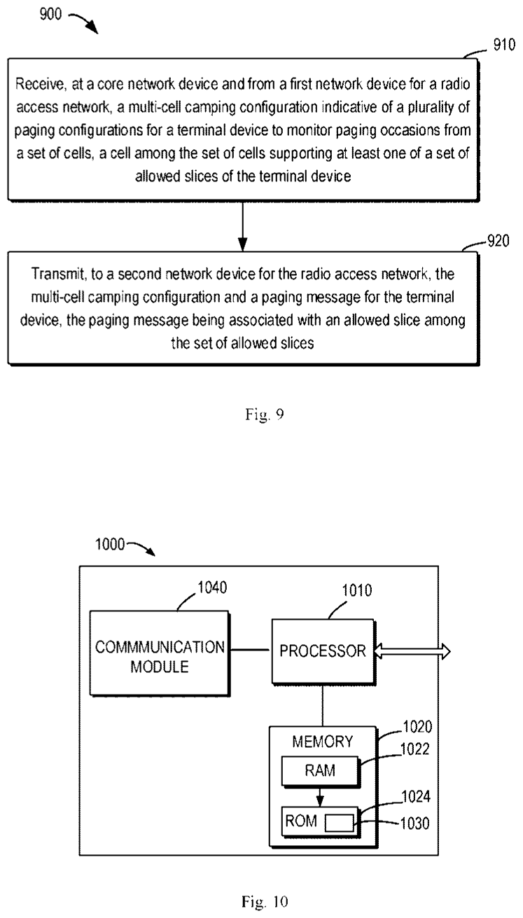

FIG. 9 shows a flowchart of an example method 900 implemented at a core network device in accordance with some embodiments of the present disclosure. For the purpose of discussion, the method 900 will be described from the perspective of the core network device 130 with reference to FIG. 1A.

At block 910, the core network device 130 receives, from a first network device 110-1 for a radio access network, a multi-cell camping configuration indicative of a plurality of paging configurations for a terminal device to monitor paging occasions from a set of cells. A cell among the set of cells supports at least one of a set of allowed slices of the terminal device 120. At block 920, the core network device 130 transmits, to a second network device for the radio access network, the multi-cell camping configuration and a paging message for the terminal device 120. The paging message is associated with an allowed slice among the set of allowed slices. The first and second network devices may be the same or different network devices.

In some embodiments, the plurality of paging configurations may comprise a plurality of radio frame sets, the terminal device being indicated to camp on one of the set of cells at one of the plurality of radio frame sets. Alternatively or additionally, the plurality of paging configurations may comprise a plurality of radio frequencies, the terminal device being indicated to camp on one of the set of cells over one of the plurality of radio frequencies. Alternatively or additionally, the plurality of paging configurations may comprise a plurality of reception beams, the terminal device being indicated to camp on one of the set of cells over one of the plurality of reception beams.

In some embodiments, in order to receive the multi-cell camping configuration from the first network device 110-1, the core network device 130 may receive a NGAP UE radio capability information indication comprising the multi-cell camping configuration. Alternatively, in order to receive the multi-cell camping configuration, the core network device 130 may receive a NGAP message associated with context of the terminal device 120 comprising the multi-cell camping configuration.

In some embodiments, when transmitting the paging message to the second network device, the core network device 130 may determine whether the second network device supports the allowed slice. Based on determining that the second network device supports the allowed slice, the core network device 130 may transmit the paging message to the second network device.

In some embodiments, when transmitting the multi-cell camping configuration and the paging message, the core network device 130 may transmit the paging message comprising the multi-cell camping configuration to the second network device. In some embodiments, when transmitting the multi-cell camping configuration and the paging message, the core network device 130 may transmit the multi-cell camping configuration to the second network device and transmit the paging message to the second network device.

In some embodiments, an apparatus capable of performing any of the method 600 (for example, the terminal device 120) may comprise means for performing the respective steps of the method 600. The means may be implemented in any suitable form. For example, the means may be implemented in a circuitry or software module.

In some embodiments, the apparatus comprises means for receiving, at a terminal device for a radio access network and from a network device for the radio access network, a multi-cell camping configuration indicative of a plurality of paging configurations for the terminal device to monitor paging occasions from a set of cells, a cell among the set of cells supporting at least one of a set of allowed slices of the terminal device; means for camping on, based on the multi-cell camping configuration, at least one cell among the set of cells; and means for receiving, based on the multi-cell camping configuration, a paging message associated with an allowed slice among the set of allowed slices from one of the at least one cell, the one of the at least one cell supporting the allowed slice.

In some embodiments, the apparatus may further comprise means for transmitting, to the network device, an indication indicative of a multi-cell camping capability of the terminal device prior to receiving the multi-cell camping configuration. In some embodiments, the multi-cell camping capability may comprise a capability of camping on different cells at different radio frame sets. Alternatively or additionally, the multi-cell camping capability may comprise a capability of camping on different cells over different radio frequencies. Alternatively or additionally, the multi-cell camping capability may comprise a capability of camping on different cells with different reception beams.

In some embodiments, the plurality of paging configurations may comprise a plurality of radio frame sets, the terminal device being indicated to camp on one of the set of cells at one of the plurality of radio frame sets. Alternatively or additionally, the plurality of paging configurations may comprise a plurality of radio frequencies, the terminal device being indicated to camp on one of the set of cells over one of the plurality of radio frequencies. Alternatively or additionally, the plurality of paging configurations may comprise a plurality of reception beams, the terminal device being indicated to camp on one of the set of cells over one of the plurality of reception beams.

In some embodiments, the at least one cell may comprise a first cell and at least one second cell. The means for camping on the at least one cell may comprise means for camping on the first cell based on determining that the terminal device is in an idle mode; means for determining that the first cell and the at least one second cell support all of the set of allowed slices of the terminal device based on determining that the first cell does not support all of the set of allowed slices of the terminal device; and means for camping on the at least one second cell based on the multi-cell camping configuration.

In some embodiments, the means for receiving the multi-cell camping configuration may comprise means for receiving a RRCReconfiguration message comprising the multi-cell camping configuration from the network device. Alternatively, the means for receiving the multi-cell camping configuration may comprise means for receiving a broadcast message comprising the multi-cell camping configuration from the network device.

In some embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

In some embodiments, an apparatus capable of performing any of the method 700 (for example, the first network device 110-1) may comprise means for performing the respective steps of the method 700. The means may be implemented in any suitable form. For example, the means may be implemented in a circuitry or software module.

In some embodiments, the apparatus comprises: means for transmitting, at a network device for a radio access network and to a terminal device for the radio access network, a multi-cell camping configuration indicative of a plurality of paging configurations for the terminal device to monitor paging occasions from a set of cells, a cell among the set of cells supporting at least one of a set of allowed slices of the terminal device; and means for transmitting, to a core network device, the multi-cell camping configuration.

In some embodiments, the apparatus comprises means for receiving, from the terminal device, an indication indicative of a multi-cell camping capability of the terminal device prior to transmitting the multi-cell camping configuration to the terminal device. In some embodiments, the multi-cell camping capability may comprise a capability of camping on different cells at different radio frame sets. Alternatively or additionally, the multi-cell camping capability may comprise a capability of camping on different cells over different radio frequencies. Alternatively or additionally, the multi-cell camping capability may comprise a capability of camping on different cells with different reception beams.

In some embodiments, the plurality of paging configurations may comprise a plurality of radio frame sets, the terminal device being indicated to camp on one of the set of cells at one of the plurality of radio frame sets. Alternatively or additionally, the plurality of paging configurations may comprise a plurality of radio frequencies, the terminal device being indicated to camp on one of the set of cells over one of the plurality of radio frequencies. Alternatively or additionally, the plurality of paging configurations may comprise a plurality of reception beams, the terminal device being indicated to camp on one of the set of cells over one of the plurality of reception beams.

In some embodiments, the means for transmitting the multi-cell camping configuration to the terminal device may comprise means for transmitting a RRC RRCReconfiguration message comprising the multi-cell camping configuration. Alternatively, the means for transmitting the multi-cell camping configuration to the terminal device may comprise means for transmitting a broadcast message comprising the multi-cell camping configuration.

In some embodiments, the means for transmitting the multi-cell camping configuration to the core network device may comprise means for transmitting a NGAP UE radio capability information indication comprising the multi-cell camping configuration. Alternatively, the means for transmitting the multi-cell camping configuration to the core network device may comprise means for transmitting a NGAP message associated with context of the terminal device comprising the multi-cell camping configuration.

In some embodiments, the apparatus further comprises means for performing other steps in some embodiments of the method 700. In some embodiments, the means comprises at least one processor and at least one memory including computer program code, the at least one memory and computer program code configured to, with the at least one processor, cause the performance of the apparatus.

In some embodiments, an apparatus capable of performing any of the method 800 (for example, the first network device 110-1, the second network device 110-2) may comprise means for performing the respective steps of the method 800. The means may be implemented in any suitable form. For example, the means may be implemented in a circuitry or software module.

In some embodiments, the apparatus comprises means for receiving, at a network device for a radio access network and from a core network device, a multi-cell camping configuration indicative of a plurality of paging configurations for a terminal device for the radio access network to monitor paging occasions from a set of cells, a cell among the set of cells supporting at least one of a set of allowed slices of the terminal device; and means for based on receiving, from the core network device, a first paging message for the terminal device, transmitting a second paging message to the terminal device from a cell supporting an allowed slice among the set of allowed slices based on the multi-cell camping configuration, the second paging message being associated with the allowed slice.

In some embodiments, the plurality of paging configurations may comprise a plurality of radio frame sets, the terminal device being indicated to camp on one of the set of cells at one of the plurality of radio frame sets. Alternatively or additionally, the plurality of paging configurations may comprise a plurality of radio frequencies, the terminal device being indicated to camp on one of the set of cells over one of the plurality of radio frequencies. Alternatively or additionally, the plurality of paging configurations may comprise a plurality of reception beams, the terminal device being indicated to camp on one of the set of cells over one of the plurality of reception beams.

In some embodiments, the plurality of paging configurations may comprise a radio frame set for a subset of cells among the set of cells. The subset of cells may support the allowed slice. The means for transmitting the second paging message to the terminal device may comprise means for determining whether a radio frame is in the radio frame set; means for determining not to transmit the second paging message to the terminal device based on determining that the radio frame is not in the radio frame set; and means for transmitting the second paging message to the terminal device based on determining that the radio frame is in the radio frame set.

In some embodiments, the means for receiving the multi-cell camping configuration may comprise means for receiving, from the core network device, the multi-cell camping configuration together with the first paging message. In some embodiments, the means for receiving the multi-cell camping configuration may comprise means for receiving, from the core network device, the first paging message comprising the multi-cell camping configuration. In some embodiments, the first paging message may be a NGAP paging message, and the second paging message may be a RRC paging message.

In some embodiments, the apparatus further comprises means for performing other steps in some embodiments of the method 800. In some embodiments, the means comprises at least one processor and at least one memory including computer program code, the at least one memory and computer program code configured to, with the at least one processor, cause the performance of the apparatus.

In some embodiments, an apparatus capable of performing any of the method 900 (for example, the core network device 130) may comprise means for performing the respective steps of the method 900. The means may be implemented in any suitable form. For example, the means may be implemented in a circuitry or software module.

In some embodiments, the apparatus comprises means for means for receiving, at a core network device and from a first network device for a radio access network, a multi-cell camping configuration indicative of a plurality of paging configurations for a terminal device for the radio access network to monitor paging occasions from a set of cells, a cell among the set of cells supporting at least one of a set of allowed slices of the terminal device; and means for transmitting, to a second network device for the radio access network, the multi-cell camping configuration and a paging message for the terminal device, the paging message being associated with an allowed slice among the set of allowed slices.

In some embodiments, the plurality of paging configurations may comprise a plurality of radio frame sets, the terminal device being indicated to camp on one of the set of cells at one of the plurality of radio frame sets. Alternatively or additionally, the plurality of paging configurations may comprise a plurality of radio frequencies, the terminal device being indicated to camp on one of the set of cells over one of the plurality of radio frequencies. Alternatively or additionally, the plurality of paging configurations may comprise a plurality of reception beams, the terminal device being indicated to camp on one of the set of cells over one of the plurality of reception beams.

In some embodiments, the means for receiving the multi-cell camping configuration from the first network device may comprise means for receiving a NGAP UE radio capability information indication comprising the multi-cell camping configuration. Alternatively, the means for receiving the multi-cell camping configuration from the first network device may comprise means for receiving a NGAP message associated with context of the terminal device comprising the multi-cell camping configuration.

In some embodiments, the means for transmitting the paging message to the second network device may comprise means for determining whether the second network device supports the allowed slice; and means for transmitting the paging message to the second network device based on determining that the second network device supports the allowed slice.

In some embodiments, the means for transmitting the multi-cell camping configuration and the paging message may comprise means for transmitting, to the second network device, the paging message comprising the multi-cell camping configuration. In some embodiments, the means for transmitting the multi-cell camping configuration and the paging message may comprise means for transmitting the multi-cell camping configuration to the second network device; and means for transmitting the paging message to the second network device.

In some embodiments, the apparatus further comprises means for performing other steps in some embodiments of the method 900. In some embodiments, the means comprises at least one processor and at least one memory including computer program code, the at least one memory and computer program code configured to, with the at least one processor, cause the performance of the apparatus.

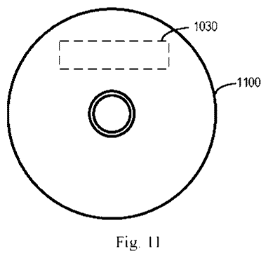

FIG. 10 is a simplified block diagram of a device 1000 that is suitable for implementing embodiments of the present disclosure. The device 1000 may be provided to implement the communication device, for example the terminal device 120, the network device 110 or the core network device 130 as shown in FIG. 1A. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1020. The processor 1010 may perform any suitable actions and processing by loading the program 1030 into the RAM 1020.

The embodiments of the present disclosure may be implemented by means of the program 1030 so that the device 1000 may perform any process of the disclosure as discussed with reference to FIGS. 2-9. The embodiments of the present disclosure may also be implemented by hardware or by a combination of software and hardware.

In some embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods as described above with reference to FIGS. 2-9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-34. (canceled)

35. A terminal device for a radio access network, comprising:
at least one processor; and
at least one memory storing instructions that, when executed by the at least one processor, cause the terminal device to perform the following operations:
receiving, from a network device for the radio access network via a radio resource control (RRC) reconfiguration message while the terminal device is in a connected mode, a multi-cell camping configuration comprising a plurality of paging configurations that specify, for each of a first cell and a second cell, respective paging occasions and corresponding radio frame sets during which the terminal device is to monitor paging on the first cell and the second cell, wherein the first cell supports a first allowed slice of the terminal device and the second cell does not support the first allowed slice;
camping on, based on the multi-cell camping configuration, both the first cell and the second cell in an idle mode, wherein camping on both the first cell and the second cell comprises alternating camping on the first cell and the second cell according to even and odd system frame numbers defined by the slice-specific camping schedule; and
receiving, based on the multi-cell camping configuration, a paging message transmitted as a radio resource control paging message during a radio frame that corresponds to the camping schedule, the paging message being associated with the first allowed slice, the paging message being received from the first cell while the terminal device is camping on the first cell during the radio frame that corresponds to the camping schedule, wherein the terminal device does not monitor paging occasions on the second cell during radio frame set corresponding to the camping schedule.

36. The terminal device of claim 35, wherein the instructions, when executed by the at least one processor, further cause the terminal device to perform the following operations:
prior to receiving the multi-cell camping configuration, transmit, to the network device, an indication indicative of a multi-cell camping capability of the terminal device.

37. The terminal device of claim 36, wherein the multi-cell camping capability comprises the following:
a capability of camping on different cells at different radio frame sets;
a capability of camping on different cells over different radio frequencies; and
a capability of camping on different cells with different reception beams.

38. The terminal device of claim 37, wherein the plurality of paging configurations comprise the following:
a plurality of radio frame sets, the terminal device being indicated to camp on one of the set of cells at one of the plurality of radio frame sets;
a plurality of radio frequencies, the terminal device being indicated to camp on one of the set of cells over one of the plurality of radio frequencies; and
a plurality of reception beams, the terminal device being indicated to camp on one of the set of cells over one of the plurality of reception beams.

39. The terminal device of claim 38, wherein the at least one cell comprises a first cell and at least one second cell, and the terminal device is caused to camp on the at least one cell by:
based on determining that the terminal device is in an idle mode, camping on the first cell;
based on determining that the first cell does not support all of the set of allowed slices of the terminal device, determining that the first cell and the at least one second cell collectively support all of the set of allowed slices of the terminal device; and
camping on the at least one second cell based on the multi-cell camping configuration.

40. The terminal device of claim 39, wherein receiving the multi-cell camping configurations comprises:
receiving a radio resource control (RRC) RRCReconfiguration message comprising the multi-cell camping configuration from the network device; or
receiving a broadcast message comprising the multi-cell camping configuration from the network device.

41. The terminal device of claim 40, wherein the multi-cell camping configuration comprises a slice-specific camping schedule that assigns different radio frame sets to different cells based on a system frame number.

42. The terminal device of claim 41, wherein the instructions, when executed by the at least one processor, further cause the terminal device to perform the following operations:
suppressing a monitoring of paging occasions on a cell that does not support the allowed slice during radio frame sets assigned to the allowed slice.

43. The terminal device of claim 42, wherein the paging message is an RRC paging message associated with a slice identifier corresponding to the allowed slice.

44. The terminal device of claim 43, wherein, during radio frame sets corresponding to the allowed slice, the terminal device monitors paging occasions on the first cell and refrains from monitoring paging occasions on the second cell.

45. A method performed by a terminal device, the method comprising:
receiving, from a network device for the radio access network via a radio resource control (RRC) reconfiguration message while the terminal device is in a connected mode, a multi-cell camping configuration comprising a plurality of paging configurations that specify, for each of a first cell and a second cell, respective paging occasions and corresponding radio frame sets during which the terminal device is to monitor paging on the first cell and the second cell, wherein the first cell supports a first allowed slice of the terminal device and the second cell does not support the first allowed slice;
camping on, based on the multi-cell camping configuration, both the first cell and the second cell in an idle mode, wherein camping on both the first cell and the second cell comprises alternating camping on the first cell and the second cell according to even and odd system frame numbers defined by the slice-specific camping schedule; and
receiving, based on the multi-cell camping configuration, a paging message transmitted as a radio resource control paging message during a radio frame that corresponds to the camping schedule, the paging message being associated with the first allowed slice, the paging message being received from the first cell while the terminal device is camping on the first cell during the radio frame that corresponds to the camping schedule, wherein the terminal device does not monitor paging occasions on the second cell during radio frame set corresponding to the camping schedule.

46. The method of claim 45, wherein the instructions, when executed by the at least one processor, further cause the terminal device to perform the following operations:
prior to receiving the multi-cell camping configuration, transmit, to the network device, an indication indicative of a multi-cell camping capability of the terminal device.

47. The method of claim 46, wherein the multi-cell camping capability comprises the following:
a capability of camping on different cells at different radio frame sets;
a capability of camping on different cells over different radio frequencies; and
a capability of camping on different cells with different reception beams.

48. The method of claim 47, wherein the plurality of paging configurations comprise the following:
a plurality of radio frame sets, the terminal device being indicated to camp on one of the set of cells at one of the plurality of radio frame sets;
a plurality of radio frequencies, the terminal device being indicated to camp on one of the set of cells over one of the plurality of radio frequencies; and
a plurality of reception beams, the terminal device being indicated to camp on one of the set of cells over one of the plurality of reception beams.

49. The method of claim 48, wherein the at least one cell comprises a first cell and at least one second cell, and the terminal device is caused to camp on the at least one cell by:
based on determining that the terminal device is in an idle mode, camping on the first cell;
based on determining that the first cell does not support all of the set of allowed slices of the terminal device, determining that the first cell and the at least one second cell collectively support all of the set of allowed slices of the terminal device; and
camping on the at least one second cell based on the multi-cell camping configuration.

50. The method of claim 49, wherein receiving the multi-cell camping configurations comprises:
receiving a radio resource control (RRC) RRCReconfiguration message comprising the multi-cell camping configuration from the network device; or
receiving a broadcast message comprising the multi-cell camping configuration from the network device.

51. The method of claim 50, wherein the multi-cell camping configuration comprises a slice-specific camping schedule that assigns different radio frame sets to different cells based on a system frame number.

52. The method of claim 51, wherein the instructions, when executed by the at least one processor, further cause the terminal device to perform the following operations:
suppressing a monitoring of paging occasions on a cell that does not support the allowed slice during radio frame sets assigned to the allowed slice.

53. The method of claim 52, wherein the paging message is an RRC paging message associated with a slice identifier corresponding to the allowed slice.

54. The method of claim 53, wherein, during radio frame sets corresponding to the allowed slice, the terminal device monitors paging occasions on the first cell and refrains from monitoring paging occasions on the second cell.
